(19) United States
(12) Patent Application Publication
(10) Pub. No.: US 2006/0253466 A1
(43) Pub. Date: Nov. 9, 2006

(54) Data Mapping Editor Graphical User Interface

(76) Inventor: Francis Robbins Upton IV, Oakland, CA (US)

Correspondence Address: FRANCIS R. UPTON IV, 567 WALAVISTA AVENUE, OAKLAND, CA, 94610, US

(21) Appl. No.: 10/908,271

(22) Filed: May 5, 2005

(51) Int. Cl. G06F 7/00

(52) U.S. Cl. 707/100

(57) ABSTRACT

An improved graphical data mapping user interface providing the immediate display of portions of the test input, sample output, or execution result output documents. Further improvements are the use of a plurality of graphical trees to represent expressions that encode the mapping instructions, and the use of a graphical tree to represent the expression that determines how map elements loop.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF INVENTION

1. Field of Invention

This invention relates to data mapping, more particularly to a graphical user interface and methods for defining a mapping between an input object and an output object.

2. Background of Invention

Businesses have exchanged documents in electronic form for a number of years. For example, a purchase order may be represented electronically using Electronic Data Interchange (EDI) standards. With the advent of the Internet this exchange of electronic documents has become easier and more prevalent, and with it, many new standards have been developed for electronic document exchange.

One of today's dominant standards is the Extensible Markup Language (XML). XML is a method of encoding data fields in an electronic document so they may be conveniently accessed by any computer system. XML by itself defines no semantics for the data; instead higher-level standards serve this purpose.

One of the difficulties in defining electronic business documents is agreeing on the exact semantic content. Because of the complexity and varied nature of businesses using electronic documents, these documents often have several hundred data fields describing different aspects of a business transaction in a way that attempts to serve a broad category of businesses. For example, the business transaction representing a notification of shipment as defined in Accredited Standards Committee X12 (ASC X12) EDI has over 650 data fields, and many of these fields can accept hundreds of pre-defined values (codes).

To make matters worse, there are several competing standards for the definition of similar business transactions. There are currently two totally different definitions of EDI (ASC X12 and UN/EDIFACT), and there are many competing standards based on XML. Some examples of these are RosettaNet, Universal Business Language (UBL), various mappings of EDI to XML, and Commerce One cXML. Each of these has an entirely different approach to capturing the semantics of business transactions.

Finally, each company has its own internal computer systems for processing these electronic business documents and the internal computer systems have independent requirements for reading and writing these documents. Many of these computer systems are several years old and use non-standard formats for documents. These internal formats are predominantly simple flat files where the data fields are defined by column positions. Most of these computer systems use database management technology to store and manipulate documents.

Businesses are faced with the problem of accepting electronic documents from their trading partners and mapping them to internal formats (which could include mapping the document directly to a database) as required by their applications. Given the wide variance of formats and internal applications, sophisticated transformations are sometimes necessary. For example, a shipment notification document may include a hierarchy of shipment, order, packaging and items. The internal business application that must process this document may require a separate record for each item, containing its order and packaging information.

The prior art to solve these problems is in three categories:
(1) Programmatic transformation languages like XSLT or XQuery, or non-transformation languages like Java™ by Sun Microsystems of Mountain View, Calif. or Perl.
(2) “Specification by drawing” oriented graphical data mapping tools.
(3) Non-drawing oriented graphical data mapping tools.

Each of the above categories of prior art is insufficient to allow a non-technical person to perform complex data mapping on large documents as required by businesses.

Programmatic Transformation Languages

One way industry has begun to deal with this problem in the context of XML documents is to specify standard languages suitable for transformation of XML documents. Extensible Style Sheet Language-Transformation (XSLT), which has been standardized by the World Wide Web Consortium (W3C), is one example. The emerging language, XQuery (also standardized by the W3C) is another approach to the problem. Both of these are rich in capabilities for mapping one document to another. However their use requires extensive expertise and training, beyond that of a non-technical user.

Other languages not designed for transformation such as Java™ or Perl are widely used in solving this problem. Constructing transformations in these languages not only requires someone trained in the art of computer programming (more so than the use of XQuery or XSLT), but also is often tedious and error-prone, with no tools to assist in testing or navigation through the mapping specification. Much of the subsequently described prior art tries to help with this, either by providing direct help to create mapping specifications in these languages (see paragraph below), or provide graphical mapping support not requiring knowledge of low-level languages.

There are data mapping tools such as Stylus Studio™ by Progress Software of Bedford, Mass. and Mapforce™ by Altova GmbH of Vienna that help with the creating and manipulation of mappings in XSLT or XQuery, but these tools still require the user to have a complete understanding of these languages, making them relatively difficult to use by a person not trained in the art of computer programming.

Specification by Drawing Mapping Tools

U.S. Pat. No. 6,823,495 to Vedula, et al (2004) along with the above mentioned Stylus Studio™ and Mapforce™ are inadequate in that they require the user to specify the mappings by placing the required functions graphically on a pane and drawing lines to connect the arguments of the functions to the input and destination data items (“specification by drawing”). While this works well for small documents, with hundreds of functions and data elements this quickly becomes unmanageable. The reason for the unmanageability is that space taken by the functions and their mappings greatly exceeds the size of the space in which they can be displayed. This problem is sometimes dealt with by having a compressed (and illegible) version of the mapping space that can then be navigated through. This is of no help however, since it is difficult to see where you are. What is necessary is precise navigation between the objects being mapped, something not provided in this prior art.

Non-Drawing Oriented Mapping Tools

Other current data mapping tools like Mercator™ by Ascential Software Corporation of Westboro, Mass. have shown capabilities for handling large documents with complex mappings, as they do not require “specification by drawing” (above). However this prior art falls short because it requires complicated text expressions and has little support for quick navigation between relevant parts of the input and output documents and the mapping instructions. These complicated text expressions are shown in a small portion of a free-form text editor with no structure, so it is very difficult to determine the structure of the expression and see clearly what it is trying to do.

Another problem with this prior art is the complexity of handling looping. Mercator™ for example, requires the user to create a different map each time a loop must be handled, which makes mapping a large document with a plurality of loops needlessly complicated. In addition, Mercator™ freely allows both individual data elements and sequences of data elements (formed by loops) to be used as arguments to functions and maps. However, the behavior of the functions when they are executing sequences is entirely different (and sometimes not allowed) than the behavior of the functions when being called with non-looping data elements. This results in much confusion when constructing maps, resulting in difficult to debug situations where the user does not get the results they expect. In short, handling looping is very complex and awkward in much of the prior art.

Most of the prior art in the “non drawing” category requires that a user complete extensive training before use. An easier way is needed, if mapping is to be done by people with little technical training.

Incremental Viewing of Test/Sample Data

Many data mapping tools allow you to specify an example test input document. At any time during the development of the map to the output document, you may execute the entire map and view the resulting output document. Sometimes the input test document and the output result document are presented along with their structures; however they are presented in their entirety and do not show the values of looping elements. In other prior art the output result document is presented in another tab so that the elements and mapping information are not visible at the same time as the output results, significantly reducing the value of seeing the output results when developing the map.

Often maps are constructed by the examination of the test input document, rather than by exclusively relying on an external specification. Since test input (and the resulting output) documents can be very large, examining these documents to find a specific value or small set of values can be tedious and time consuming. Checking for the expected output is difficult when you must view the entire output and documents are very large or the mapping is very complex. To work around this, some current products have debugging environments that allow the user to step through or set break points during the execution of the mapping code. This again requires extensive training and experience with programming techniques to develop maps.

Finally, it is also often desirable to work with a sample output document. In contrast to the test input document, the sample output document is previously prepared to show the correct or proposed results of a mapping before the mapping was constructed. It is often helpful to view the sample output document when constructing the map in an incremental fashion, for example just by clicking on an element of the output you can see the portion of the sample output document. This is not possible in any prior art.

### BACKGROUND OF INVENTION—OBJECTS AND ADVANTAGES

Accordingly, several objects and advantages in the present invention are:
(1) The need for tedious map debugging is eliminated because any portion of the map can be executed incrementally, seeing only the desired output;
(2) Map development and maintenance is reduced by the ability to quickly access small portions of the test input and sample output documents as they relate to elements of the map;
(3) There is a uniform simple model for functions and their relationship with loop data; functions are categorized and named by how they relate to looping making them easier to understand and use;
(4) The structures for handling data elements and how they are related to loops and functions follow a consistent, flexible and easy to understand model; and
(5) The convenient tree representation for expressions can be used uniformly to specify the aspects of mapping other than producing the output value, such as for loops, optional elements, validation, and other constructs as specified with XML Schema.

Further objects and advantages of my invention will become apparent from a consideration of the drawings and ensuing description.

### SUMMARY OF INVENTION

The present invention provides a graphical user interface and method for creating a mapping between an input electronic document and an output electronic document. Henceforth, the definition or schema for an electronic document shall be called a structure. A structure is a tree consisting of a single root node, intermediate nodes (nodes that have child nodes), and leaf nodes (nodes with no child nodes). Leaf nodes represent data fields that may be assigned values. Henceforth, nodes of a structure tree shall be called elements. The input and output structures may represent any form of electronic document consisting of a set of data fields arranged in a hierarchical fashion, including but not limited to XML, EDI, spreadsheets, database tables, flat files, and comma separated files.

Elements are associated with many properties such as their data type, length, and minimum and/or maximum number of times they may appear. An element is said to loop if the maximum number of times it may appear is greater than one. An element is said to be optional if the minimum number of times it may appear is zero. Elements are also associated with a group type. A group type of Sequence indicates that all of the child elements must appear in order. A group type of Choice indicates only one of the child elements may appear.

The user interface enables the user to construct a set of rules for mapping the input structure to the output structure. These rules may be a direct mapping, indicating the output field value is the same as the value of some input field. More sophisticated rules may be created using one or more functions to transform one or more input field values to a single output field value. The use of a function is called an expression.

The user interface consists of an input structure region, an output structure region, a functions region, and an expression region. The input and output structure regions hold the definitions of the input and output structures respectively. The functions region contains all of the functions, such as Add, Copy, Count, etc. that may be used to create a mapping. The functions are arranged into categories such as String, Comparison, and Aggregate. The expression region contains the expression(s) to be applied to the output node, given the output node its value.

No attempt is made to show the entire map visually through a drawing or require the user to manipulate the drawing. Rather, only one set of expressions is shown at a time with adequate space devoted to its comfortable manipulation. Superior navigation using menus between the expression elements and structure elements eliminates the need for a drawing to guide navigation. Finally, the entire mapping can be exported to a spreadsheet in order to view it in the most compact space and get a general overview.

Defining the Map

An expression tree contains expressions as nodes. Each node in the tree is either an expression representing a call to a single function or a reference to the value of an element in the input or output structure. The children of each expression are the arguments to that expression. An expression uses the values from each of its children as arguments, and returns the result of the function execution to its parent. The result of the expression tree is the result of the root expression.

The use of a visual tree of expression nodes (rather than the typical text in most of the prior art) allows full manipulation with drag and drop techniques and makes the expression tree very easy to understand and navigate. Though representation of expressions as a visual tree is in the prior art, it is rarely used for this purpose in the context of a graphical data mapping system.

The user interface can be manipulated using drag and drop with a pointing device such that the user can drag an input element to an output element and an expression that copies the value of the input node will automatically be created. Or the user can select an output element with a pointing device and drag a function to the expression area (which is associated with the output node). Then one or more other functions or input elements can be dragged to the expression area creating an expression tree that is used to provide the value of the output element.

Elements can be associated with the following types of expressions:
Value—defines the value of the output element.
Loop—defines the way in which a looping output element will occur in the output document. Typically, a “SequentialLoop” function is used to relate each instance of the output element with a corresponding instance of an input element. However, many other functions are possible.
Choice—used for output elements whose parent element has a group type of Choice. This expression determines the conditions to select the output element for output document.
Optional—used for an optional output element. This expression defines the condition under which the output element is emitted.
Validation—used on input or output elements to allow custom written rules to determine if the value of the element is valid according to the business requirements.
   Testing the Map

The user may associate a test input document with the map to aid in development and testing. Once such a document is associated, the user may select any input element and execute a menu operation to cause the values in the test document associated with that input element and its children to be displayed. Executing the “display input” operation on the root element in this manner will display the entire test document. Executing “display input” on an intermediate or leaf element will display only that element's (and its children's) values. Similarly, the user may associate a sample output document and display that document incrementally by executing “display output” on an output element.

In a manner similar to the above, a user may select “display test results” for any output element, which will cause the values resulting from the execution of the map on that output element (and its children) to be displayed. This feature, unique in this invention, allows the user to quickly and easily see the results of a small portion of a mapping in isolation, eliminating the need to run the mapping of the entire document and engage in a complex debugging process if there is a problem.

The features of partial viewing the test document and partial execution of the map provide an enormous productivity gain in creating and testing maps that is not available in the prior art. This is because the user can invoke these features quickly at the same time they are examining or specifying a mapping instantly determining its correctness.

### DRAWINGS—FIGURES

FIG. 1 is a front elevation view of the entire graphical user interface.

FIG. 2 is a schematic of the relationship between the graphical user interface and the map execution engine showing structure and document flow between them.

FIG. 3 is a front elevation view of a tree.

FIG. 4 is an example input and output structure.

FIG. 4A shows example element paths.

FIG. 4B is a front elevation view of the element properties region.

FIG. 5 is a front elevation view of the function region.

FIG. 6 is a front elevation view of expression region, showing the value expression tree.

FIG. 6A is a front elevation view of expression region, showing the optional expression tree.

FIG. 6B is a front elevation view of expression region, showing the validation expression tree.

FIG. 6C is a front elevation view of expression properties region.

FIG. 6D is a front elevation view of expression region, showing the choice expression tree.

FIG. 7 is a front elevation view of expression region, showing the loop expression tree.

FIG. 7A shows example loop contexts.

FIG. 7B is a front elevation view of expression region, showing an aggregate loop expression.

FIG. 8 is an example of navigation from an element reference.

FIG. 8A is an example of navigation from an input element to output elements.

FIG. 9 is a front elevation view of showing a portion of an example XML input document.

FIG. 9A is a front elevation view of showing a portion of a result XML document.

FIG. 9B is a front elevation view of showing a portion of a result EDI document.

### DRAWINGS—LIST OF REFERENCE NUMERALS

1—graphical user interface; 2—function region; 3—expression region; 4—input structure region; 6—output structure region; 7—element properties region; 8—expression properties region.
12—function tree; 14—input structure; 16—output structure.
20—value expression tree; 21—optional expression tree; 22—validation expression tree; 23—choice expression tree; 24—loop expression tree.
30—element; 32—function; 34—expression; 34a—aggregate argument loop expression; 36—element reference; 35—expression argument; 37—loop indicator; 38—loop context ancestor.
40—selected element name; 42—expression tree tab.
50—map execution engine; 52—repository.
60—input document; 61—test input document; 62—output document; 64—input structure definition document; 66—output structure definition document; 67—sample output document.
70—input document view region; 74—map result document view region.
80—property name; 82—property value.
90—tree; 92—tree node; 93—icon; 94—tree node expanded indicator; 95—tree node contracted indicator; 96—selected tree node indication; 97—scroll bar; 98—pop-up menu.

### DETAILED DESCRIPTION

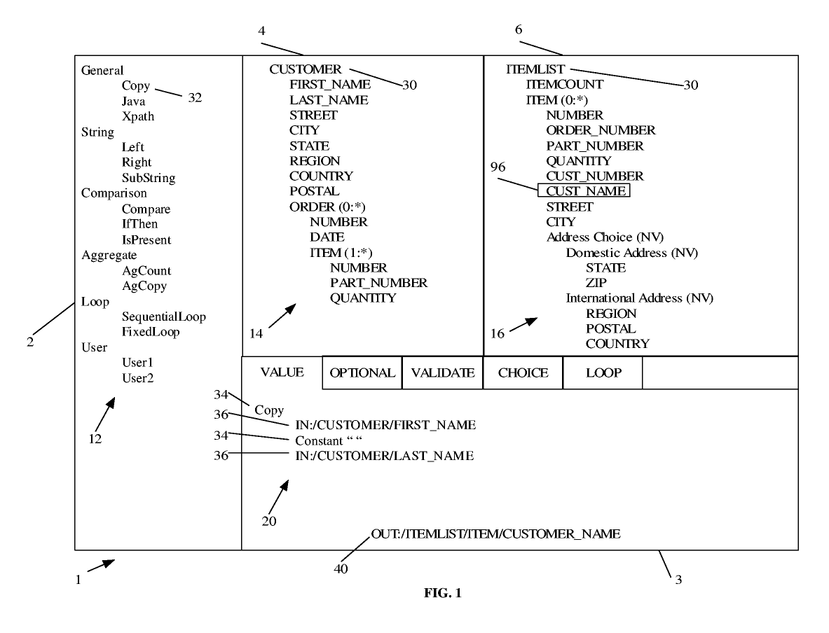

FIG. 1 shows an exemplary graphical user interface 1, having function region 2, expression region 3, input structure region 4, and output structure region 6. The function region 2 contains the function tree 12. The expression region 3 contains the value expression tree 20 as shown here. The expression region 3 may also contain other expression trees as shown below. The input structure region 4 contains input structure 14. The output structure region 6 contains output structure 16. Graphical user interface 1 specifies a map that is the set of rules for producing an instance of the output structure 16 from the input structure 14. This map can be executed at any time during its definition process, or may be saved and executed in a runtime environment shown below.

Each of the trees 12, 14, 16, and 20 consist of a one or more of nodes arranged in a hierarchical fashion as is well known in the art. The use of the term node can apply to any tree. Each of the nodes of the function tree 12 is a function 32 (for clarity, only one such node is marked in FIG. 1). Each of the nodes of the input/output structures 14/16 is an element 30 (for clarity, only two such nodes are marked in FIG. 1). An expression tree, of which the value expression tree 20 is an example, may contain one or more expressions 34 and zero or more element references 36.

The input/output structures 14/16 represent a definition of a collection of data fields. These may refer to XML documents, EDI documents, spreadsheets, positional documents, database tables, and any other type of document having a collection of data fields.

When an element 30 is selected by user input (with a mouse, keyboard or other pointing device) the selected tree node indication 96 appears. Only one input/output element 30 may be selected at a time. At the time of selection, the expression region 3 shows an expression tree corresponding to the element. In FIG. 1 the value expression tree 20 is shown; however a different expression tree such as the loop expression tree may be shown depending on which element 30 is selected. The selected element name 40 is shown to further indicate which input/output element 30 is selected. Further details on the relationship between the expression trees and selected element are provided below.

The value expression tree 20 contains a Copy expression 34 whose first child is an element reference 36. In the example shown in FIG. 1, the expression 34 refers to the Copy function that returns the concatenation of each of its arguments. Further details on the construction and use of expression trees are provided below.

The result of the execution of the value expression tree 20 becomes the value for its corresponding selected output element. Thus the execution of the map defined by the state of the graphical user interface 1 shown in FIG. 1 will result in the value of the output CUST_NAME element having the value of input FIRST_NAME, a space, and LAST_NAME elements.

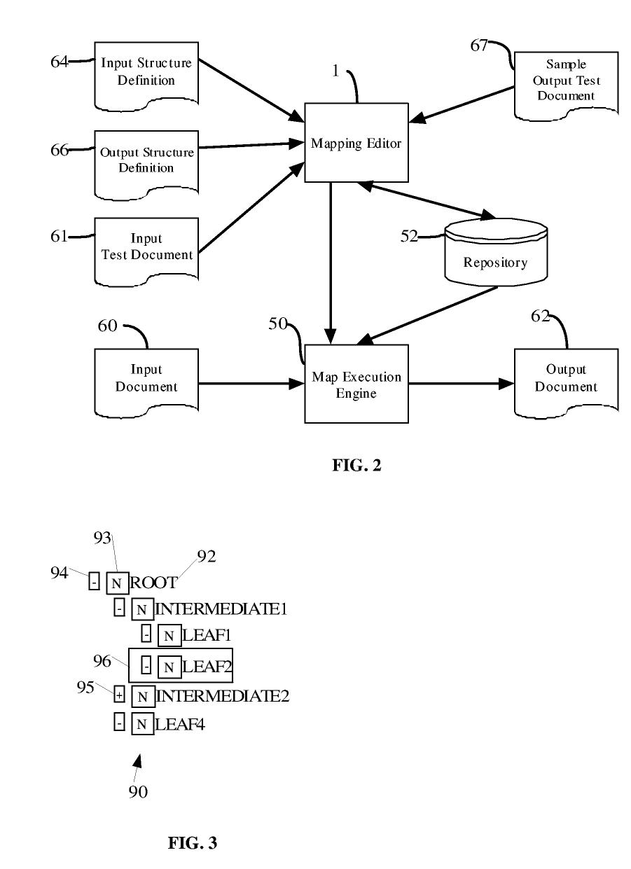

FIG. 2—Map Definition and Execution

FIG. 2 shows the graphical user interface 1 that is used to create and modify a map. In the preferred embodiment, a user may provide the contents of the input/output structures 14/16 using input/output definition documents 64/66. Some examples of these definition documents are XML Data Type Definitions (DTD), XML Schema documents, EDI transaction definition documents, sample XML documents, and database schemas. Alternatively, a user may directly specify the contents of input/output structures 14/16 by directly manipulating those trees.

During the development of the map it is often desirable to test the map with an test input document 61. The test input document 61 can be used both to allow the user to see potential input values to aid in the construction of the map, or to actually execute the map and see the resulting output document. Similarly, the map developer often has a sample document representing the output structure 67, and it is helpful to show portions of that sample output document 67 when developing and testing the map.

The definition of the map is stored in the repository 52. Execution of the map is accomplished by a map execution engine 50, which reads an input document 60 and produces an output document 62. In one embodiment the definition of the map may be translated to XQuery or XSLT that is then used to process the input document 60 producing the output document 62. However many other types of map execution are possible, including generating Java, C++, or SQL code, or by directly interpreting the map and executing it with a proprietary execution engine.

General Graphical User Interface Objects

One embodiment of this invention can be produced using a number of standard graphical user interface objects well known in the art. These are discussed briefly here to review their functionality. These objects include:
Tree—used to represent a hierarchical collection of objects.
Drag and Drop—used to indicated the relationship between one object and another.
Scrolling—used when a region is larger than the area it may be presently displayed.
Popup Menu—shows a menu associated with a tree node or region.
Dialog region—shows a region on top of the main graphical user interface 1, typically used to ask a question or show information temporarily.
Property Sheet—shows a set of properties associated with an object, each property having a name and value.

FIG. 3 shows a tree 90, which consists or one or more tree nodes 92 (for clarity, only the root node is marked with 92). The tree behaves in the standard manner well known in the art. Each tree node 92 may have an icon 93 that indicates the type of tree node. Each tree node 92 with children has a tree node expanded/contracted indicator 94 which can be used to make all of the children visible or hide all of the children. If the node's children are shown, they are shown in order below the node and indented slightly.

The user may select any tree node 92, and when it is so selected a selected tree node indication 96 appears on the same line as the tree node 92. Only one tree node 92 may be selected at a given instance within a single tree 90. If at the time a user selected a tree node 92, a different tree node 92 was currently selected in the same tree, the selection indicator 96 will be removed from the previously selected tree node 92.

Drag and drop allows the user to select a tree node 92, for example by placing the cursor over the object and clicking on the left mouse button, and drag this selected object to another location in the graphical user interface 1. Once the selected tree node 92 is in the desired location, the mouse button is released and the tree node 92 is “dropped” at the location. The drop location may be another tree node 92, a space between tree nodes (which may be indicated by a line shown in between the tree nodes), or the area surrounding the tree but in the region containing the tree, for example regions 4-8 in FIG. 1.

Scrolling is done by the appearance of scroll bars on the side and/or bottom of the region containing a tree. Should the tree become larger than can be shown in the available space of the region, a scroll bar automatically appears. The user may use the scroll bar to adjust the visible portion of the tree within its containing region.

One method of displaying a pop-up menu is to click the right button of a mouse that causes a menu whose items are related to the object at the location of the mouse pointer. Pop-up menus can either be associated with a tree node 92, or they can be associated with the area surrounding the tree but in the region containing the tree, for example regions 4-8 in FIG. 1. As a pop-up menu contains menu items, some of these items may be disabled and shown as grayed out in the event that they are not applicable.

A dialog region may be shown in response to various events, for example the user may select a tree node 92's properties. These properties are shown in a dialog region that covers a portion of the graphical user interface 1. The dialog region may contain any information, including text of portions of an input/output document, a question to the user, a property sheet, an error message, etc. The dialog region remains on top of the graphical user interface 1 until the user takes an action to dismiss it, typically by clicking on a button shown near the bottom of the dialog region.

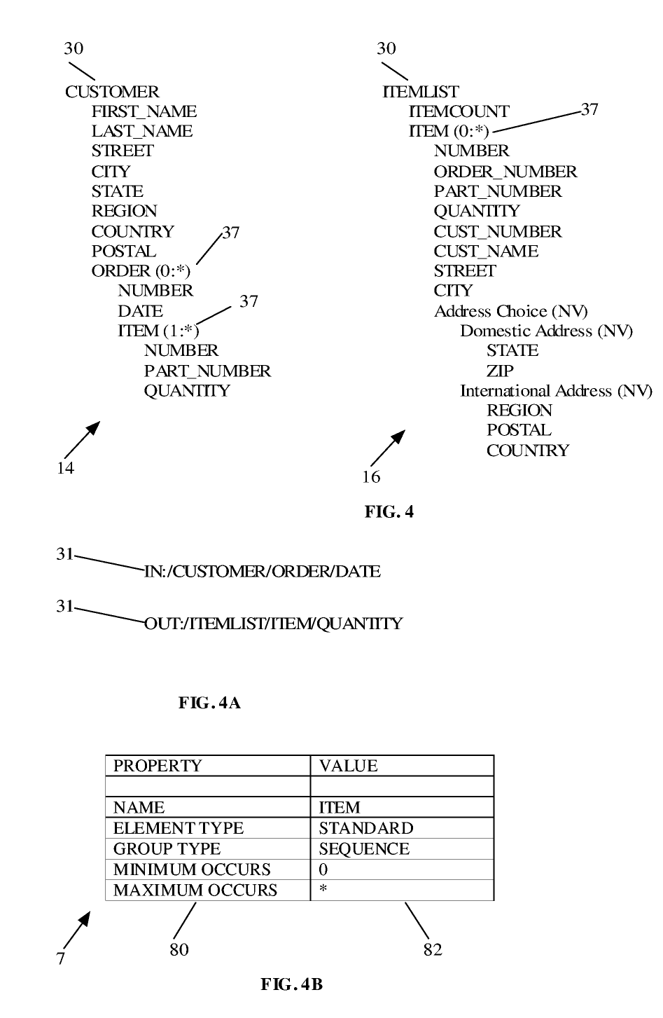

Tree nodes 92 and other objects may be associated with a set of properties. Each property has a unique name, for example “Name”, and a value that is specific to the object, for example “ITEMLIST” as shown in the element 30 in FIG. 1. FIG. 4B shows an example property sheet that is associated with an element 30. The property sheet shows all of the properties associated with its object. Property sheets may be contained within a dialog region. Property sheets may optionally allow the user to alter the value of one or more properties.

FIG. 4/4A/4B—Example of Input and Output Structures

FIG. 4 shows examples of input structure 14 and output structure 16. These structures are each instances of a tree as shown in FIG. 3, and are comprised of elements 30 (for clarity only the root element in each structure is marked with 30). In this example, the input structure represents a customer record that contains the customer's first name, last name, and address information. This input customer record may contain zero or more orders, each order consisting of a number, date, and one or more line items. Each line item contains a part number, quantity and price. The loop indicator 37 associated with the ORDER element shows the minimum and maximum number of times the element may occur. If an “*” character is shown as the maximum number of occurrences then it is unlimited. If the element occurs a maximum of 1 time, the loop indicator 37 is not present.

The example output structure 16 consists of a subset of the data of the input structure 14 with a different organization. The output structure 16 represents a list of items that contains zero or more items. Each item contains a sequence number, the customer name, customer number, address information, order number, part number and quantity. The address information is presented in two alternatives, only one of which may appear at a time. The Address Choice element thus has a Group Type of Choice. The domestic address alternative contains a street, city, and state. The international address alternative contains the street, city, region, and country.

The output elements marked NV are not visible in the actual documents corresponding to the output structure. These are called non-visible elements, and are used to provide additional grouping information, mainly for loops and choices. In this example, if the address is a domestic address, the STATE and ZIP elements are required, but if it is an international address the REGION, POSTAL, and COUNTRY elements are required.

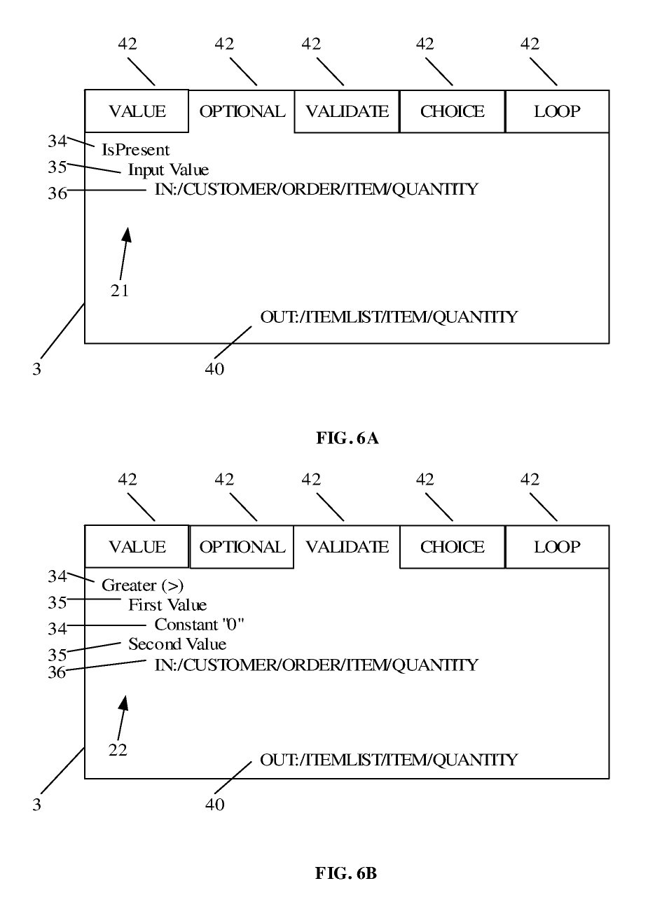

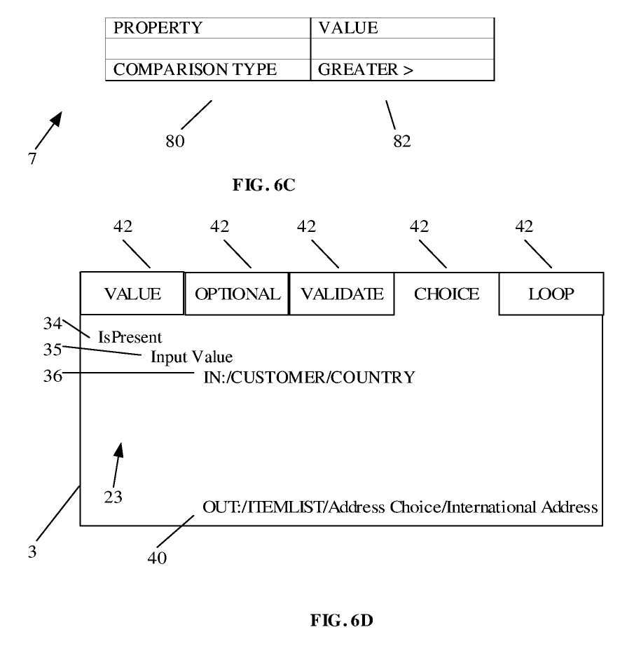

Another example of the utility of the non-visible elements is when a document such as a flat file must be mapped. The typical structure of a flat file is a series of records, each record containing a plurality of fields. Often there are different types of records, and a field near the beginning of the record is used to identify the type of record (called the record type field). This type of structure cannot be represented easily in the typical hierarchical view without the use of non-visible elements, as there is no root element that is named. In this case, the root element can be a non-visible choice, and each of the record definitions is a child of the root. The record type field can be used to indicate which record is to be processed. Further aspects of non-visible and choice elements are discussed below in FIG. 6D, Choice Expression.

FIG. 4A shows an element path 31 that is a text string that represents a specific element 30. An example of where the element path 31 might appear is in the selected element name 40 of FIG. 1. The element path 31 may be constructed by concatenating the element 30 of each of the ancestor elements of the desired element in order of their proximity to the root element. This is done in the same manner as an ordinary file path name in an operating system. Finally, the prefix “IN:” or “OUT:” is added to the element path 31 depending on whether the element 30 is input or output.

FIG. 4B shows the element properties region 7 that is associated with an element 30. This region may be shown using a pop-up menu selected on the element 30 and selecting the “Properties” menu item. The element properties region 7 is shown in a dialog region. The properties of the elements are defined as follows:

Definition List 1

| Term | Definition |
|---|---|
| Name | The name of the element |
| Group Type | None, if this element has no children. |
| | Sequence, if all children occur in order |
| | Choice, if only one of the children may occur. |
| Minimum Occurs | The minimum number of times the element can occur. |
| Maximum Occurs | The maximum number of times the element can occur. |

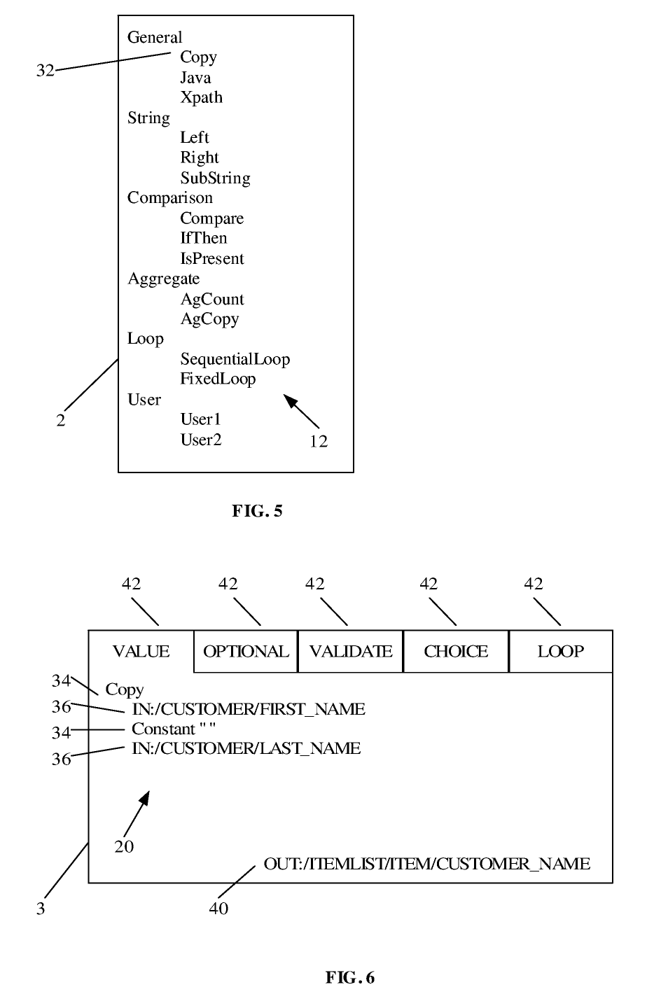

A typical embodiment will have many more properties not shown here such as data type, length, etc.
FIG. 5—Functions

FIG. 5 shows the function region 5 containing an example of the functions that may be available for use in mapping. These functions are contained in an instance of a tree as shown in FIG. 3. Intermediate tree nodes are used to represent categories of functions. Leaf nodes are functions 32.

A function is used by dragging it to an expression tree. When the function is dropped on an expression tree it becomes an expression referring to the function, and the expression generally has the same name as the function (the exceptions to this are noted below).

Functions can have either a fixed number of named arguments, which appear in the expression tree as expression arguments, or can have an unlimited number of arguments. This is shown in the expression tree by the absence of any named arguments.

FIGS. 6, 6A, 6B, 6C, 6D—Expression Trees

FIG. 6 shows the expression region 3 containing an example expression. There are five different expression trees that may be shown in the expression region 3. This is implemented using a set of tabs well known in the art. Only one expression tree is shown at a time. The names of each expression tree are shown in the expression tree tabs 42. A user may select an expression tree tab 42 that causes that tab to change in a way to indicate to the user it is selected, and causes the expression tree associated with that tab to appear in the expression region 3. Depending on which element 30 in FIG. 1 is selected, certain expression tree tabs 42 may be disabled and not selectable. Henceforth the selected element 30 in FIG. 1 is referred to as the corresponding element in relation to the expression trees 20-24 that may be viewed while the element is selected. In addition, when the corresponding element is selected, depending on the type of element, a specific expression tree will be automatically selected. The specific rules about this are covered below. Also when the corresponding element is selected, the selected element name 40 will be set to the element path 31 in FIG. 4A value of the corresponding element.

The value expression tree 20 defines the value of the corresponding element. The value expression tree 20 is used only when the corresponding element is an output element. In the example, the value of element is comprised of the result of the Copy expression 34, which refers to the Copy function (not shown). The first argument is an element reference 36 to the FIRST_NAME element in the input structure (not shown). The second argument is an expression 34 referring to a Constant function (not shown). The value of the Constant expression in the case of this expression 34 is a single space. The third argument is an element reference 36 to the LAST_NAME element in the input structure (not shown). Thus, if the value of the FIRST_NAME element in an input document is “Martha” and the value of the LAST_NAME element in the document is “Lyman”, then the result of this value expression tree 20 is “Martha Lyman”. The Copy expression 34 is an example of an expression that has a variable number of arguments; this expression can have any number of child expressions that are each arguments. The user can easily determine this is the case by the absence of expression arguments as children of the Copy expression 34.

The most common use of the value expression tree 20 is to simply copy the value of a given input element to a given output element. This involves the use of the Copy expression with a single argument of an element reference referring to the input element. This type of expression is produced automatically in the output element's value expression when an input element is dragged and dropped on an output element. In this case, we say that the input element is “mapped” to the output element.

The value expression tree tab 42 is enabled whenever an output element 30 in FIG. 1 is selected that has a “Group Type” property value of “None”. When such an output element 30 is selected, in addition to the value expression tree tab 42 being enabled, the tab is also selected, so that the value expression tree 20 is always initially shown.

Referring to FIG. 6A, the optional expression tree 21 returns a Boolean value indicating whether or not the corresponding output element (not shown) is to be included in the output document. In this example, the IsPresent function is used to indicate the output element is to be included only if the QUANTITY input element is present. In more detail, the IsPresent expression 34 indicates a call to the IsPresent function (not shown). This expression has one possible expression argument 35 called Input Value, which refers to the value being tested for presence. The Input Value argument is satisfied by the QUANTITY element reference 36. The IsPresent expression is an example of an expression with a fixed number of arguments.

Referring to FIG. 6B, the validation expression tree 22 returns a Boolean value indicating the validity of the corresponding output element (not shown). If the result of the validation expression tree 22 is true, the output element is considered valid, otherwise it is considered invalid and an error or warning is reported as part of the result of the execution of the map. In this example, the QUANTITY is checked for a value greater than zero. The Greater expression 34 indicates a call to the Compare function 32 in FIG. 5. When the Compare function is dropped in the validation expression tree 22 it initially appears as “Compare-select comparison type”. Referring to FIG. 6C, the comparison type is selected by accessing the expression properties region 8, which could be done by selecting the “Properties” popup-menu item on the Compare expression 34. The “Greater” value can be selected for the “Comparison” property. At this point the name of the Compare expression 34 changes to “Greater”, as it appears in FIG. 6B. This illustrates that expressions can have both properties, specified via expression properties region 8 in FIG. 6C and any number of expression arguments 35. Some characteristics of expressions are better suited to properties since they are determined statically at the time of creation of the map, and other characteristics are better suited to arguments since they depend on values present in the input or output data. Allowing both types of mechanisms significantly improves the user experience associated with creating/manipulating maps because it reduces steps in the specification of expressions.

Referring to FIG. 6D, the choice expression tree 23 is used only when the corresponding element is child of an element having a “Group Type” property of “Choice”. The result of the choice expression tree 23 is a Boolean value indicating whether or not the corresponding element is emitted into the output. Thus using a choice expression, the user can control the emission of a group of output elements in a single expression. The notion of a choice is well known in the art, and is provided in specification languages like XML Schema. Unlike the prior art, this invention provides a direct and flexible means to specify the inclusion of a branch of the choice. The value of the choice expression is further enhanced when used with the non-visible element feature. Recall that an element may be marked non-visible. This means the element does not actually appear in the document, but is used as a placeholder for mapping expressions. In FIG. 4, the desired output, if the address is a domestic address, are the elements STATE and ZIP. However, if the address is an international address, the output would be the REGION, POSTAL, and COUNTRY elements. This can be done using the choice expression tree 23 in FIG. 6D. This choice expression is associated with the International element, which is a child of the output AddressChoice element. Both of these elements are non-visible. The element reference 37 is to the input COUNTRY element. So, if the COUNTRY element is present, the International branch of the choice is emitted, causing each of the output REGION, POSTAL, and COUNTRY elements to be emitted, whether or not values are mapped to them.

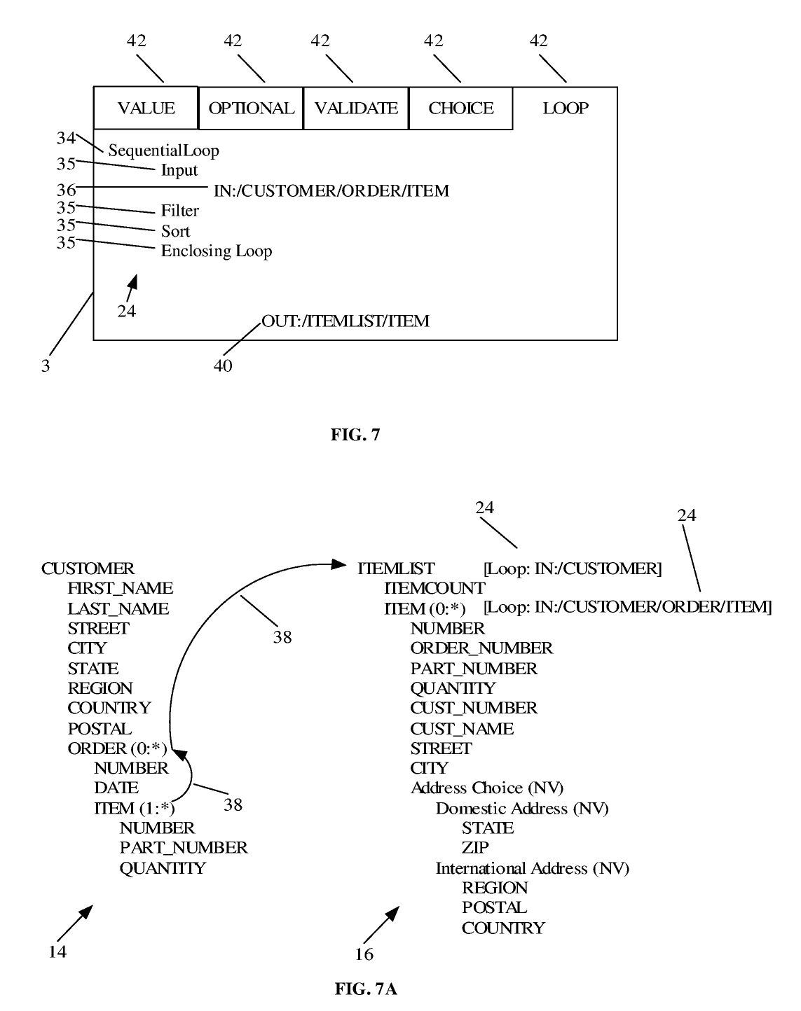

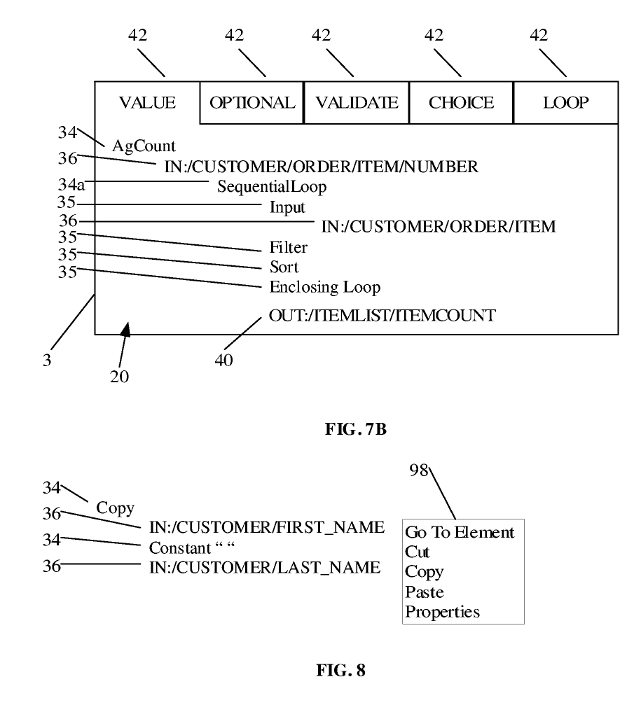

FIGS. 7, 7A, and 7B—Loop Expressions

Referring to FIG. 7, the loop expression tree 24 is shown only when the corresponding element (not shown) loops, that is, has a maximum occurs value of greater than one. The loop expression determines the number of times the corresponding element loops and the context in which element references are resolved. The root of the loop expression tree must be an expression referring to a Loop function. Referring to FIG. 5, Loop functions are those functions 32 that are in the Loop category.

Some basic examples of loop functions are SequentialLoop, which causes the corresponding element to loop one for one matching the looping of another element; SingleElement which causes the corresponding element to be emitted at most once, matching a single element at the specified index of a loop; FixedLoop which causes the corresponding element to be emitted a fixed number of times.

Loop functions may also have filtering and sorting capability. For filtering, an expression tree defining a constraint (using an IfThen function, for example) may be an argument to a loop function. For sorting, a loop function may contain a variable function argument that comprises the element references of elements on which to sort.

Furthermore, loop functions can be used to relate loops. For example, a document may have a loop of items to be ordered. It may have a separate loop, elsewhere in the document, with requested ship dates for each item. In both loops, the position in the loop refers to the same item. In this case, it might be desirable to produce an output document where data from each of these related input loops is combined into a single output loop for the items. A loop function (could be called LockStepLoop) can do this by having as its argument each of the separate loops, in which it will process these loops in parallel.

Many other types of loop functions are possible for more specialized applications.

Each element reference is a reference to a single value, even if the referenced element either loops or is within a loop (an ancestor element loops). The loop expression is the means of determining which instance of loop values are to be used for an element reference at any given time. Each element that loops may provide a loop context that is used to resolve the specific instance of any element references that referring to children of the looping element. The loop context is provided simply by specifying a loop expression tree 24 to be associated with the element.

FIG. 7A shows an illustration of the loop context to resolve input elements. It is based on the example structures found in FIG. 4. An abbreviated version of the loop expression tree 24 is shown in brackets next to the elements strictly for explanatory purposes which indicates that these elements have that loop expression (this form of showing a loop expression tree 24 will typically not be used in the preferred embodiment). The loop expressions in the figure show that the ITEM output element loops corresponding to the ITEM input element, and that the ITEMLIST output element loops corresponding to the CUSTOMER input element. Thus for the single CUSTOMER in the input, one ITEMLIST is produced, and for each ITEM instance in the input, one ITEM instance in the output is produced. There are two loop contexts in this map, one for output element ITEMLIST and one for output element ITEM. The loop context ancestor relationships 38 are not actually present in the preferred embodiment of the graphical user interface; they are shown for illustration purposes only.

If the input PART_NUMBER element is mapped to the output PART_NUMBER element, the applicable loop context is the output ITEM element. Thus one instance of the output ITEM element is generated for each instance of the input ITEM element, and the relationship between the input PART_NUMBER element and the output PART_NUMBER element is known because it is associated with the corresponding instances. The loop context ancestor line 38 from the output ITEM element to the input ITEM element illustrates this.

If the input ORDER/NUMBER element is mapped to the output ITEM/NUMBER element, the loop instance of the input ORDER element that the input ORDER/NUMBER element comes from must be determined. To do this, the loop context ancestor path must be followed using the loop context ancestor lines 38. The search for a loop context begins with the nearest enclosing output element ancestor that has a loop context. In this case, that is the output ITEM element. Since that loop context is associated with a descendent of the input ORDER element (it is associated with the input ITEM element), the loop context ancestor 38 relationship is followed to a loop context in the input ORDER element. This loop context has been established by automatically providing a default loop expression tree 24 associated with the input ORDER element which uses the SequentialLoop expression. This loop context allows the correct value of the input ORDER/NUMBER element to be determined.

As the loop context is determined by a reference to an element, loop functions (such as the LockStepLoop function) may reference elements in different and unrelated loops. The loop context for these references can be resolved using the rules described above.

Referring to FIG. 7B, sometimes it is necessary to support functions that process values for all instances of a loop, for example to count or sum some element of a loop. Aggregate functions have this capability. Referring to FIG. 5, Some examples of aggregate functions are those functions in the Aggregate category. The result of an expression using an aggregate function follows the same rules for looping as any other expression. However each argument of an aggregate function requires its own aggregate argument loop expression 34a. This allows the aggregate function to consider all instances (or whatever instances the aggregate argument loop expression 34a presents) of the argument expression 36 when considering its result.

In another embodiment, an aggregate function may be specified by having the looping expression associated at the level of the aggregate function, rather than with each argument. In this case, all of the arguments are processed in the context of the specified loop expression.

In either embodiment, the aggregate function is implemented such that it is aware of the loop expression associated with each argument (or the function as a whole). This function can process all of the elements according to the rules of the applicable loop expression and perform whatever calculation necessary to produce its result. Additional examples of aggregate functions are: mathematical functions like average, standard deviation, returning the minimum or maximum value; functions that manipulate or concatenate strings; and special purpose functions that can process looping data. Many other types of aggregate functions are possible.

Other embodiments may have different ways of representing the relationship of a loop expression to an aggregate function.

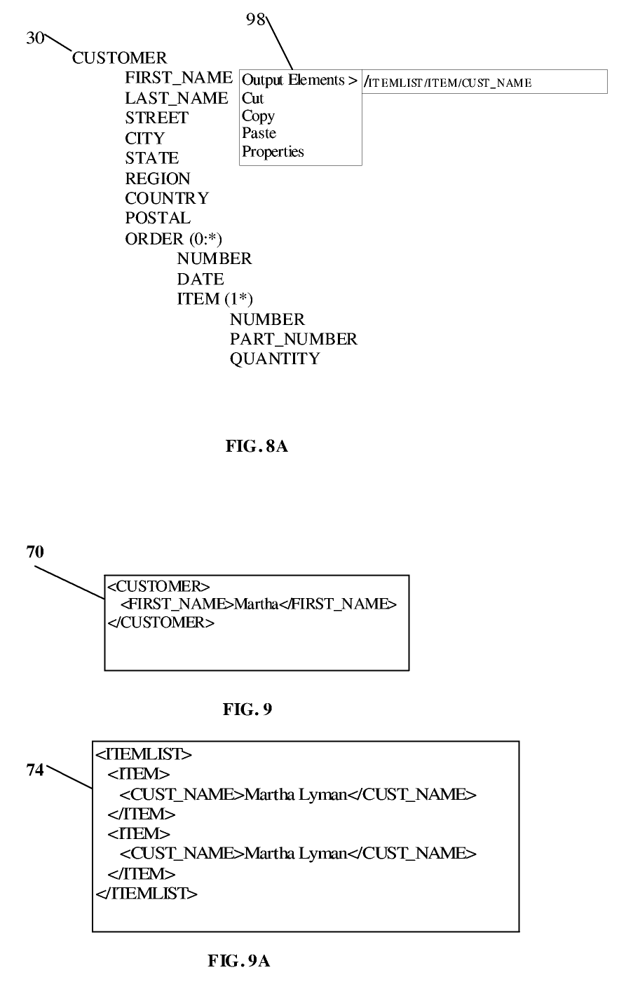

FIGS. 8 and 8A—Navigation

FIG. 8 shows a portion of an expression tree, with a popup menu 98 that is associated with element reference 36. This allows the user to cause the input element (not shown) to be selected in the input structure. Using this feature the user can quickly see the context of the input element referred to in the mapping. By providing a “back” button well known in the art, the user can immediately return to the original selected element reference 36. This sort of quick navigation is essential to reducing the time required to get information to prepare maps.

FIG. 8A shows another navigation feature, which allows the user to quickly see which output elements an input element is mapped to. To do this, the user selects an input element 30, causes the pop-up menu 98 to be invoked, selects the “Output Elements” item on the menu, and it will show the fully qualified element name of each output element whose value expression tree (not shown) contains a reference to the selected input element. The desired output element may be selected on the pop-up menu causing the output element to be selected and its expression tree shown.

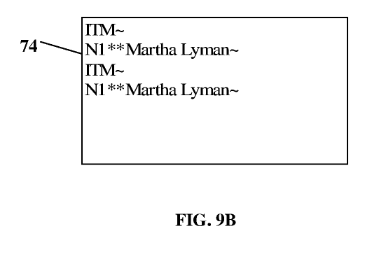

FIGS. 9, 9A, 9B—Displaying Input and Results

FIG. 9 shows a portion of an example input document in the input document view region 70, where the representation of the input document is XML. This is typical of what is shown in a dialog region in response to a pop-up menu invocation of “display input” executed at the FIRST_NAME element. As there is no looping involved, the document has only one FIRST_NAME element, which is shown in its parent CUSTOMER element. In general, whenever a single element is shown in the input, output or map execution results, all of its parent elements are shown to provide context.

FIG. 9A shows a portion of the map execution results for a particular output element in the map results document view region 74, which happens when the user selects “display test results” on the output element CUST_NAME. In this case, the CUST_NAME element is a child of the ITEM element which loops. For the example document, there are two ITEM elements, each having the same CUST_NAME value of “Martha Lyman”. As with FIG. 9, the XML representation of the output document is shown.

FIG. 9B shows the map results document view region 74 resulting from the same action of selecting the CUST_NAME output element and selecting “display test results”. In this case, however the representation of the output document is EDI rather than XML. Note in the EDI case, the presence of the ITM segment (which loops) and provides context for the N1 segment that contains “Martha Lyman” as one of its element values. This is to illustrate that in the looping case, the proper context segments (in EDI) and elements (in XML) are shown so the user can tell which instance of the loop is being viewed (in this case, both instances of the loop have been shown in both XML and EDI).

The display of a portion of any type of document (input, output, test input, sample output) has number of possible embodiments. For example, the display of a document can be shown initially in XML, and the user can choose to have the same display rendered immediately in EDI, or some other format. This choice may be made as part of the window in which the display occurs, so as to instantly change the format of the display without executing the portion of the map that caused the display.

In another embodiment, there can be information added to the display to indicate the index of elements that loop. In yet another possible embodiment, the entire document might be displayed with the desired portion highlighted using color, underlining or a special font. In yet another embodiment, where the elements to be displayed loop, the user can specify a range of elements to display, or to see all elements in the loop. In yet another embodiment, the display of the document may be in a graphical tree form, or any other graphical form to better show the content of the displayed elements. In yet another embodiment, the display can show a single (or a small number of) elements of a loop at a time and the user can navigate back and forth through the loop, showing one (or a small number) of elements at a time. There are many other embodiments possible in the display of a portion of a document.

Limiting

Although the description above contains many specificities, these should not be construed as limiting the scope of the invention but as merely providing illustrations of some of the preferred embodiments of this invention.

What is claimed is:

1. A data mapping editor graphical user interface comprising:
an input structure region adapted to display a graphical representation of an input structure comprising one or more elements;
an output structure region adapted to display a graphical representation of an output structure comprising one or more elements; and
a means of displaying a portion of a document instance consisting of a group of an input document instance or a sample output document instance where the portion of said document instance corresponds to an element of a structure consisting of a group of the input structure or the output structure.

2. A data mapping editor graphical user interface comprising:
an input structure region adapted to display a graphical representation of an input structure comprising one or more elements;
an output structure region adapted to display a graphical representation of an output structure comprising one or more elements;
a map execution engine capable of transforming an input document instance to a result output document instance; and
a means of displaying a portion of said result output document instance where the portion of said document instance corresponds to an element of the result output document instance.

3. A data mapping editor graphical user interface comprising:
an input structure region adapted to display a graphical representation of an input structure comprising one or more elements;
an output structure region adapted to display a graphical representation of an output structure comprising one or more elements; and
the use of a plurality of graphical expression trees that are associated with each said element.

4. A data mapping editor graphical user interface comprising:
an input structure region adapted to display a graphical representation of an input structure comprising one or more elements;
an output structure region adapted to display a graphical representation of an output structure comprising one or more elements; and
the use a graphical expression tree to specify the method for looping that is associated with each said element that loops.
